(19) United States
(12) Patent Application Publication
(10) Pub. No.: US 2008/0184248 A1
(43) Pub. Date: Jul. 31, 2008

(54) OPTIMIZATION OF JOB SCHEDULING FOR RESOURCE CLUSTERS WITH ACCESS CONTROL AND USAGE REPORTING

(75) Inventors: Ankur Barua, Sunnyvale, CA (US); Gary Lee Thwing, Watsonville, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/668,441

(22) Filed: Jan. 29, 2007

(51) Int. Cl. G06F 9/50

(52) U.S. Cl. 718/104

(57) ABSTRACT

A user is enabled to reserve computer resources using a calendaring graphical user interface (GUI). The calendaring GUI enables viewing of resources currently in use and/or reserved for future use, and/or available for scheduling, that is stored within a scheduling data store. The user may employ the calendaring GUI to visually identify available timeslots to reserve resources, and/or modify, or delete a scheduled job. When the user schedules a job, a reservation identifier (RID) may be provided, which may then be submitted with the job to a distinct scheduler program. Each scheduler program may employ the RID and scheduling data store to determine whether to execute the job, or place the job in a sleep mode. If a job uses more or less than a reserved time, the scheduling data store may be revised to reserve additional time, or to relinquish unused resources.

### TECHNICAL FIELD

The invention relates generally to managing computing resources, and more particularly but not exclusively to enabling future job scheduling of cluster computing resources using a calendar and/or an automatic reservation mechanism to schedule and enable execution of a job.

### BACKGROUND

Job scheduling has been identified as one of the key challenging problems for managing the resources on computer environments. In many of today's computer environments, there remain a limited number of available resources. Such resources may include not only the computers themselves, including its memory, number of processors, speeds of the processors, storage space, or the like, but may also include related print services, applications, constraints on licenses, constraints based on quality of service agreements, or the like. With such varied types of resources it may be difficult and sometimes time consuming for a user to manually determine where to run their job.

Many users of these resources may submit numerous jobs to be run in accordance with various site specific policies, scheduling constraints, or the like. In a highly utilized compute environment often times the demand for resources is larger than the available capacity. Therefore, there may often be jobs waiting to be executed as soon as resources become available. Moreover, users may have a desire to have selected jobs run repetitively, at a particular time of day, or the like. Ensuring the right job gets the right resources at a specified time is often a problem. The inability to adequately schedule certain jobs for a specific time with specific resource may result in wasted time, resources, and money. Therefore, it is with respect to these considerations and others that the present invention has been made.

### BRIEF DESCRIPTION OF THE DRAWINGS

Non-limiting and non-exhaustive embodiments of the invention are described with reference to the following drawings. In the drawings, like reference numerals refer to like parts throughout the various figures unless otherwise specified.

For a better understanding of the invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a network device that may be included in a system implementing the invention;

FIG. 3 illustrates a logical flow diagram generally showing one embodiment of a process for job resource scheduling employing a calendaring interface;

FIG. 4 illustrates one embodiment of an example user interface useable as a calendaring interface for future job scheduling; and

FIG. 5 illustrates one embodiment of example user interface useable in submitting a job request to a scheduler, in accordance with the invention.

### DETAILED DESCRIPTION

The invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods or devices. Accordingly, the invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “job” refers to any unit of work executable by a computing device. Thus, a job may be a single program, or a group of programs that work together. In one embodiment, a job may also be a subset of a program, such as a subroutine, paragraph, function, or the like. In another embodiment, a job may be a script, an applet, or the like.

As used here, the term “cluster” refers to multiple loosely coupled network devices that cooperate to provide client devices access to a set of services, resources, or the like, over the network. Members in the cluster may be employed to increase the reliability and availability of the access. Typically, within a cluster one of the members may be designated as a master. The master, in one embodiment, may be configured and arranged to direct a job to one or more of the members based on a variety of criteria. The term cluster may sometimes be used to describe a compute farm, server farm, or the like, and thus such terms may be used interchangeably.

Briefly stated the invention is directed towards a system, apparatus, and method for enabling a user to reserve one or more computer resources using a calendaring interface. In one embodiment, the compute resources are associated with a cluster of network resources. The calendaring interface may employ a variety of graphical interfaces. In one embodiment, the calendaring interface is accessible using a web browser. The calendaring interface is configured and arranged to enable viewing of resources currently in use, reserved for future use, and/or available for future scheduling. The resources and other scheduling information may, in one embodiment, be stored within a scheduling data store, such as a database, spreadsheet, or the like. In one embodiment, the calendaring interface may constrain a view of resources based on the user's rights to access a given resource. Thus, in one embodiment, if the user is constrained from scheduling a resource during a defined timeslot, that timeslot might be blocked out, or otherwise not made visible to the user. In any event, the user may employ the calendaring interface to visually identify possible timeslots to reserve for executing a job. The user may also employ the calendaring interface to modify and/or delete a scheduled job. When the user schedules a job, with the requested resources, a reservation identifier (RID) may be provided that enables the user to subsequently submit the job for execution. In one embodiment, each job is submitted to a schedule wrapper program. The schedule wrapper program may employ the RID to determine when to execute the job. In one embodiment, a job may also be submitted to the schedule wrapper absent scheduling resources, and hence without an RID. In this embodiment, the schedule wrapper performs an analysis to determine when and where to execute the ‘unscheduled’ job. In one embodiment, the schedule wrapper may employ a least loaded, or a most available analysis to determine where and when to execute the job. In any event, the schedule wrapper may then assign an RID to the job. In one embodiment, a distinct schedule wrapper program (e.g., separate instantiations) is associated with each job. Each schedule wrapper program examines the provided RID, examines the scheduling data store, and determines whether to execute the associated job, or place the job into a sleep mode. If a job executes beyond an estimated end time (e.g., beyond a timeslot), the scheduling data store may be revised to reserve resources for an additional time. In one embodiment, if the job executes within less than the scheduled time, the scheduling data store may also be revised to un-reserve unused resources. Usage reporting may also be performed using the scheduling data store.

### Illustrative Operating Environment

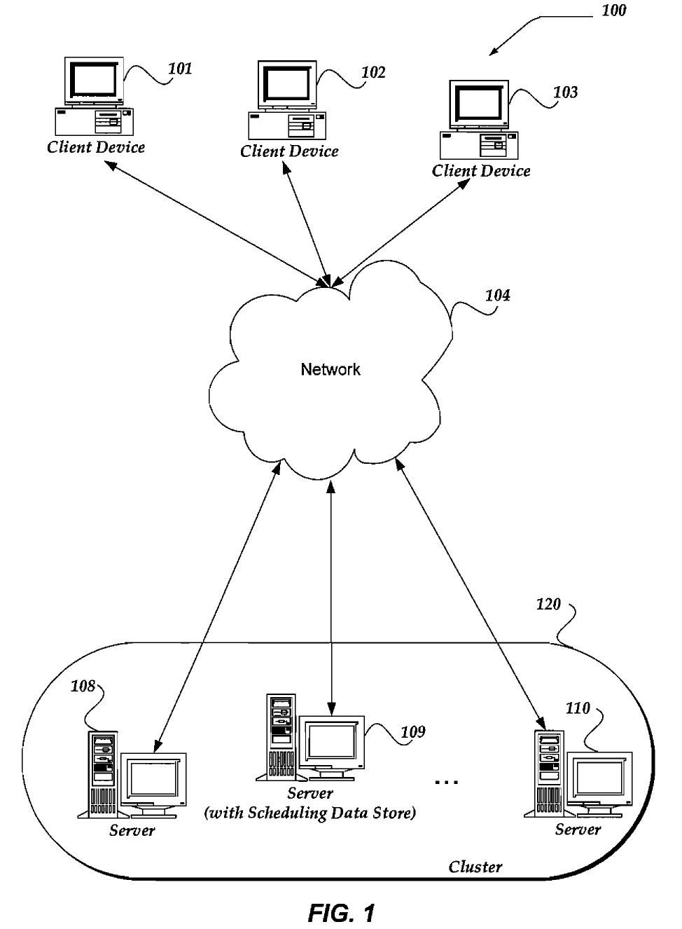

FIG. 1 illustrates one embodiment of an environment in which the invention may operate. However, not all of these components may be required to practice the invention, and variations in the arrangement and type of the components may be made without departing from the spirit or scope of the invention.

As shown in the figure, system 100 includes client devices 101-103, network 104, and servers 108-110. Client devices 101-103 are in communication with servers 108-110 through network 104. In one embodiment, as shown, servers 108-110 may operate within a cluster 120. However, the invention is not constrained to a cluster configuration, and any other configuration or arrangement of computer resources, such as servers 108-110, may also be employed, including for example, a peer-to-peer arrangement, or the like. Moreover, as shown server 109 is illustrated as including a scheduling data store. However, the invention is not so constrained, and the scheduling data store may also reside on another server, a server not within cluster 120, or even be distributed across a plurality of servers, without departing from the scope of the invention.

Generally, client devices 101-103 may include virtually any computing device capable of connecting to another computing device to send and receive information, including emails, requests for information from a server, submission of a job to be executed on at least one of servers 108-110, querying job status requests, or the like. The set of such devices may include devices that typically connect using a wired communications medium such as personal computers, multiprocessor systems, microprocessor-based or programmable consumer electronics, network PCs, or the like. The set of such devices may also include devices that typically connect using a wireless communications medium such as cell phones, smart phones, radio frequency (RF) devices, infrared (IR) devices, integrated devices combining one or more of the preceding devices, or virtually any mobile device. Similarly, client devices 101-103 may be any device that is capable of connecting using a wired or wireless communication medium such as a PDA, POCKET PC, wearable computer, and any other device that is equipped to communicate over a wired and/or wireless communication medium.

Client devices 101-103 may further include a client application that is configured to manage various actions. Moreover, client devices 101-103 may also include a web browser application that is configured to enable a user to interact with other devices and applications, over network 104. In one embodiment, the web browser is configured to provide various functions, including, but not limited to, authentication, enabling multiple requests for information, submit a job, view a calendaring interface to the scheduling data store, or the like.

Client devices 101-103 may also include other client applications, such as might enable access to another computing device, perform queries for status of a job, submit a job for execution, receive results of a job, or the like.

Network 104 is configured to couple client devices 101-103, with other network devices, such as each other, and/or servers 108-110. Network 104 is enabled to employ any form of computer readable media for communicating information from one electronic device to another. In one embodiment, network 104 is the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 104 may further employ a plurality of wireless access technologies including, but not limited to, 2nd (2G), 3rd (3G) generation radio access for cellular systems, Wireless-LAN, Wireless Router (WR) mesh, or the like. Access technologies such as 2G, 3G, and future access networks may enable wide area coverage for network devices, such as client devices 101-103, or the like, with various degrees of mobility. For example, network 104 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like.

Furthermore, remote computers and other related electronic devices could be remotely connected to either LANs or WANs via a modem and temporary telephone link. In essence, network 104 includes any communication method by which information may travel between client devices 101-103 and servers 108-110.

Additionally, network 104 may include communication media that typically provides computer-readable instructions, data structures, program modules, or other data. In one embodiment, network 104 may employ a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

Servers 108-110 may include any computing device capable of communicating network packets with another computing device. Each packet may convey a piece of information. A packet may be sent for handshaking, e.g., to establish a connection or to acknowledge receipt of data, or the like. The packet may include information such as a request, a response, or the like. In one embodiment, the packet may include a job to be executed on at least one of servers 108-110. In another embodiment, the packet may include a response associated with one or more jobs. In one embodiment, the packet may include scheduling information useable in scheduling a job for execution, and/or modifying a scheduled job.

Generally, packets received and or sent by servers 108-110 will be formatted according to TCP/IP, but they could also be formatted using another transport protocol, such as User Datagram Protocol (UDP), Internet Control Message Protocol (ICMP), NETbeui, IPX/SPX, token ring, a proprietary protocol format, or the like. Moreover, the packets may be communicated between servers 108-110 and client devices 101-103 employing HTTP, HTTPS, or the like. However, in one embodiment, client devices 101-103 may also be configured to access a command line interface (CLI), or any other type of interface, on one of servers 108-110 that may be configured to enable submission of jobs, obtaining status of a job, and/or receiving results from a job.

In one embodiment, servers 108-110 may operate as compute servers, configured to receive a job and to execute the job. For example, servers 108-110 operate to perform messaging jobs, File Transfer Protocol (FTP) jobs, database jobs, perform web services, print services, or any of a variety of other types of jobs. For example, in one embodiment, servers 108-110 may be configured to receive a job that may perform a statistical analysis, generate, and/or test software components, or the like.

Additionally, each of servers 108-110 may be configured to perform a different operation. Thus, for example, server 108 may be configured as statistical analysis system with special licenses for employing statistical programs, while server 109 may be configured as a database server with associated licenses for use of the database. Further, one of servers 108-110 may be configured to operate as a print server, with communication to a plurality of printers. Thus, in one embodiment, a job may include instructions for printing.

Moreover, each of servers 108-110 may be configured with different software and/or hardware components, including different licenses, applications, memory, processors, or the like. In one embodiment, various resources of each of servers 108-110 may be managed by a use policy, service level agreement, or the like. However, in another embodiment, servers 108-110 may also be configured the same, without departing from the scope of the invention.

In addition, in one embodiment, servers 108-110 may be configured to operate within a cluster, such as cluster 120. Moreover, in one embodiment, at least one of servers 108-110 may be configured to manage the scheduling data store, described in more detail below. As illustrated, server 109 includes the scheduling data store that is useable to manage scheduling of jobs to be executed using cluster 120. In one embodiment, as described in more detail below, a user of client devices 101-103 may access a calendaring interface, such as a graphical user interface (GUI) to interact with the scheduling data store. In one embodiment, the GUI may be displayed through a web browser, however the invention is not so limited, and other applications, scripts, applets, or the like, may also be employed.

Devices that may operate as servers 108-110 include personal computers desktop computers, multiprocessor systems, microprocessor-based or programmable consumer electronics, network PCs, servers, or the like.

### Illustrative Scheduler Environment

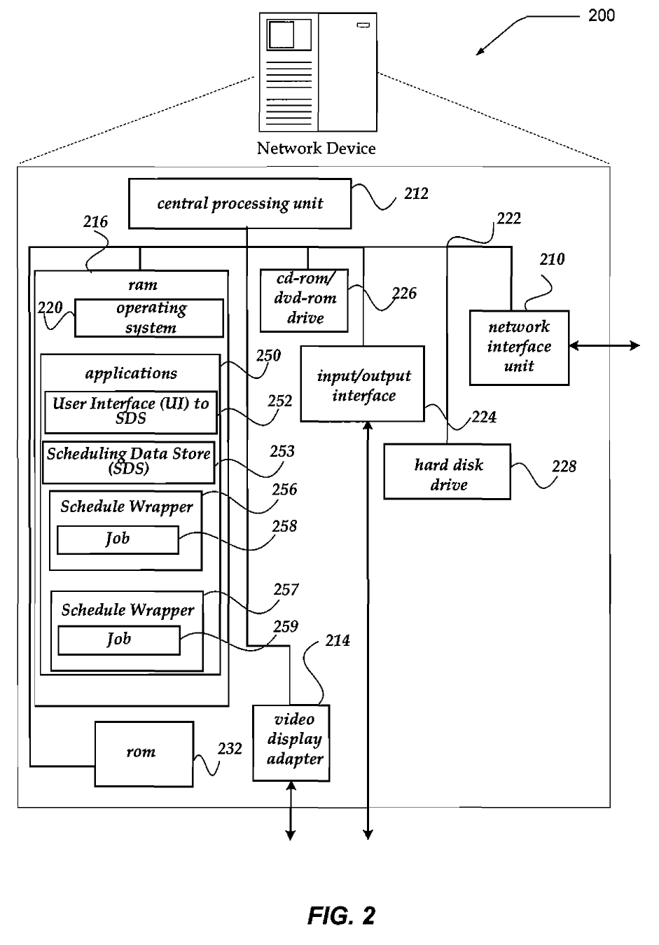

FIG. 2 shows one embodiment of a network device, according to one embodiment of the invention. Network device 200 may include many more or less components than those shown. The components shown, however, are sufficient to disclose an illustrative embodiment for practicing the invention. Network device 200 may represent, for example, one of servers 108-110 of FIG. 1.

Network device 200 includes central processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Moreover, although a single processing unit is illustrated, network device 200 may employ multiple processing units, multiple processors, or the like, without departing from the scope of the invention.

As illustrated in FIG. 2, network device 200 also can communicate with the Internet, or some other communications network, such as network 104 in FIG. 1, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Network device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion. Moreover, network device 200 may further include applications that support virtually any secure connection, including TLS, TTLS, EAP, SSL, IPSec, or the like. Similarly, network device 200 may include applications that support a variety of tunneling mechanisms, such as VPN, PPP, L2TP, and so forth.

Network device 200 also includes input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 may be utilized to store, among other things, application programs, databases, or the like.

The mass memory also stores program code and data. One or more applications 250 are loaded into mass memory and run on operating system 220. Examples of application programs may include email programs, routing programs, schedulers, calendars, database programs, word processing programs, HTTP programs, security programs, and so forth. Mass storage may further include applications and/or data such as user interface to a scheduling data store (UI) 252, scheduling data store (SDS) 253, as well as zero or more jobs 258-259, with associated schedule wrappers 256-257.

SDS 253 may include a database, spreadsheet, text, folder, file, or the like, that is configured to maintain and store information useable in scheduling various computer resources. As such, SDS 253 may include, for example, information about a resource that may be available for scheduling. For example, where the resource is a server the information may include an identifier of the server, a ranking of the server within a cluster, a size, capacity, or the like, associated with the server, a constraint on access to the server for a given user, user group, or the like, service level agreement constraints, or the like. Where the resource is an application, the information may include service level agreements, a number of licenses available, and/or other constraints on uses of the application, or the like. SDS 253 may also be configured to store and manage information about a reservation of time and resources by a user. Thus, SDS 253 may further include a user identifier (UID), a reservation identifier (RID), identifier(s) for the reserved resource(s), number of jobs reserved by a user, number of jobs currently executing, a start time for a job, an estimated or expected end time for a job, a time a job reservation is submitted or created, a time a job reservation is modified, as well as virtually any other information useable in managing job scheduling.

Moreover, in one embodiment, SDS 253 may include a data analysis tool that is configured to enable analysis of the scheduling information. Such data analysis tool may include scripts, applications, or the like. In one embodiment, the data analysis tool may be configured to generate one or more reports, graphs, or the like, indicating resource consumption, allocation, or the like, including which user, and/or user group used how much of a give resource over some time period, whether a resource is overscheduled, or the like. In one embodiment, the data analysis tool may also be employed to provide chargeback billing reports, or the like.

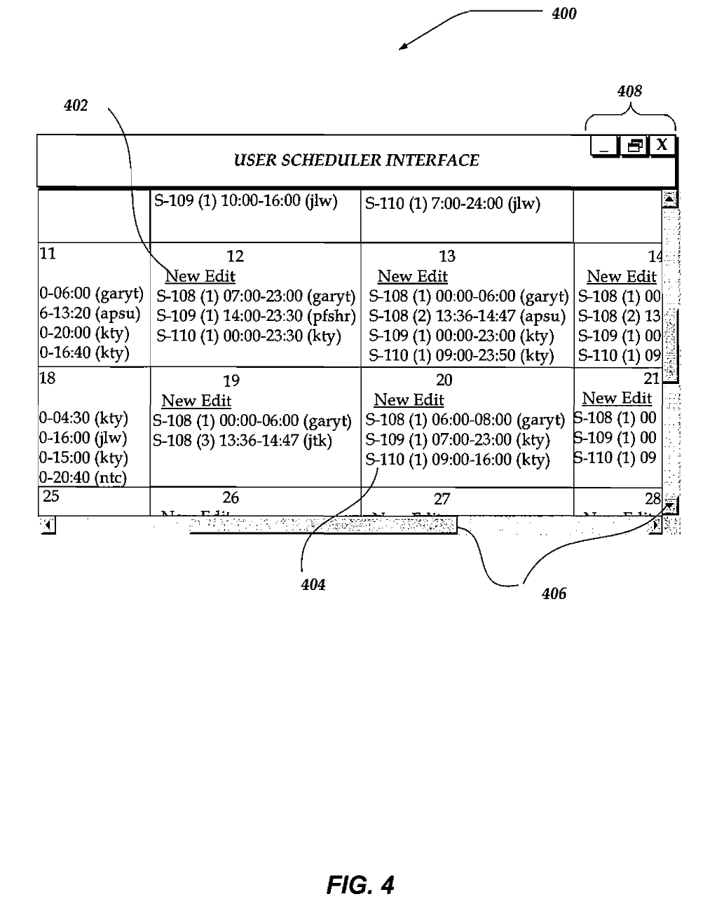

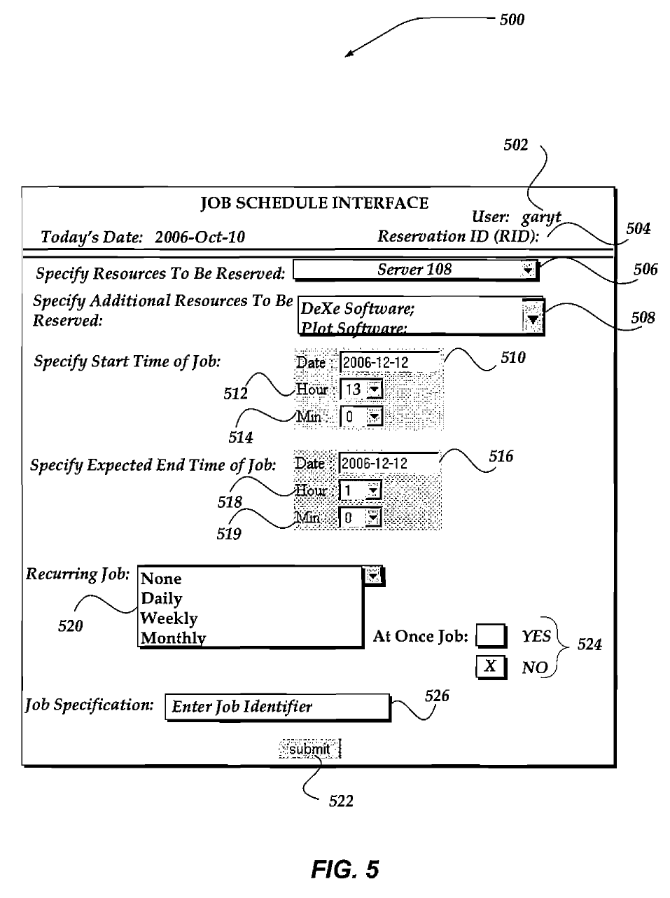

One embodiment, of UI 252 is described in more detail below in conjunction with FIGS. 4-5. Briefly, however, UI 252 represents a user interface useable by a user to communicate with SDS 253 for use in scheduling jobs. In one embodiment, UI 252 includes a calendar that displays scheduled jobs for various resources, and provides visibility as to available timeslots and resources to a user. In one embodiment, UI 252 may employ information about a user and information within SDS 253 to constrain a view of the information within SDS 253. For example, where a user is constrained from accessing and/or scheduling a particular server, or other resource, that server or resource scheduling information might not be made visible to the user.

In one embodiment, UI 252 may be displayed to a user using a web browser. However, the invention is not constrained to web browsers, and other applications, scripts, applets, or the like, may also be employed to provide a graphical interactive display to the SDS 253 information for use in making visible and enabling scheduling of jobs and resources.

Schedule wrappers 256-257 are instantiations of a scheduler application that may be employed to enable execution of a submitted job. In one embodiment, jobs 258-259, whether scheduled using UI 252, or through automatic reservation at run time, may be submitted with a schedule wrapper application. The schedule wrappers 256-257 may, in one embodiment, also receive an RID when jobs 258-259 are submitted.

The user may employ an interface such as described below in conjunction with FIG. 5 to submit the job to schedule wrappers 256-257. In another embodiment, however, the user may employ a Command Line Interface (CLI) to associate schedule wrappers 256-257 to jobs with an RID and to further submit the jobs for scheduled execution.

Schedule wrappers 256-257 may employ the RID to query SDS 253 to determine whether jobs 258-259 are scheduled to execute. If it is determined that the jobs 258-259 are not currently scheduled to execute, in one embodiment, schedule wrappers 256-257 may place the associated jobs 258-259 into a sleep mode. In one embodiment, schedule wrappers 256-257 may enable sleep mode by calling an operating system sleep system call, or the like, for a predefined time. In one embodiment, the predefined time may be anywhere from a few seconds to several minutes, or even hours. However, the predefined time may be virtually any time period, without departing from the scope of the invention. At the end of the predefined time, schedule wrappers 256-257 may again employ the RID to query SDS 253 to determine if the associated job is now scheduled to execute. If the job is scheduled to execute at the present time (or the time has just elapsed, depending on the sleep time resolution, scheduling time resolution, or the like), one of schedule wrappers 256-257 executes the associated job.

Schedule wrappers 256-257 may also be employed to submit jobs 258-259 in an automatic reservation or “at once’ reservation mode at run time. In this embodiment, a user may submit a job for scheduling without employing UI 252. The user may employ an interface such as described below in conjunction with FIG. 5 to submit a job to schedule wrappers 256-257. In another embodiment, however, the user may employ a Command Line Interface (CLI) to associate a schedule wrappers 256-257 to jobs and to further submit the job for execution. In one embodiment, the user may not have an RID to include in the job submission.

Schedule wrappers 256-257 may then query SDS 253 to determine when and where to execute the submitted job. Schedule wrappers 256-257 may employ a variety of mechanisms to determine where and when to execute the job, including but not limited to a least loaded approach, a most available approach, a round robin approach, a least cost approach, or the like.

For example, use of the least loaded approach may include examining scheduling information within SDS 253 to select a server and/or other resource that has a lowest workload, including scheduled jobs. For example, in one embodiment, an examination may be performed to determine a number of jobs scheduled to run and/or are currently running during an expected job duration for the resources. In one embodiment, where two or more servers ‘tie’ for having the lowest workload, then a highest ranked server, resource, or the like, may be selected. In another embodiment, least loaded may be determined based on job duration, as well as, or instead of a number of scheduled jobs. For example, in one embodiment, an interval of time which is scheduled for various jobs to run during the expected job duration for the resources may be examined to determine the least loaded resource and timeslot.

In one embodiment, the most available approach may include selecting the server and/or other resource having the maximum available job capacity. In one embodiment, CPU cycles, I/O throughput, licensing constraints, Service Level Agreements, user constraints, or the like, may also be employed to select the server and time to execute the at run time job. In any event, if a resource is currently unavailable for the job, schedule wrappers 256-257 may schedule the job to execute at some later time when the resource is available. In one embodiment, schedule wrapper 257-257 may also obtain an RID through SDS 253 for use in scheduling and executing the job.

### Generalized Operation

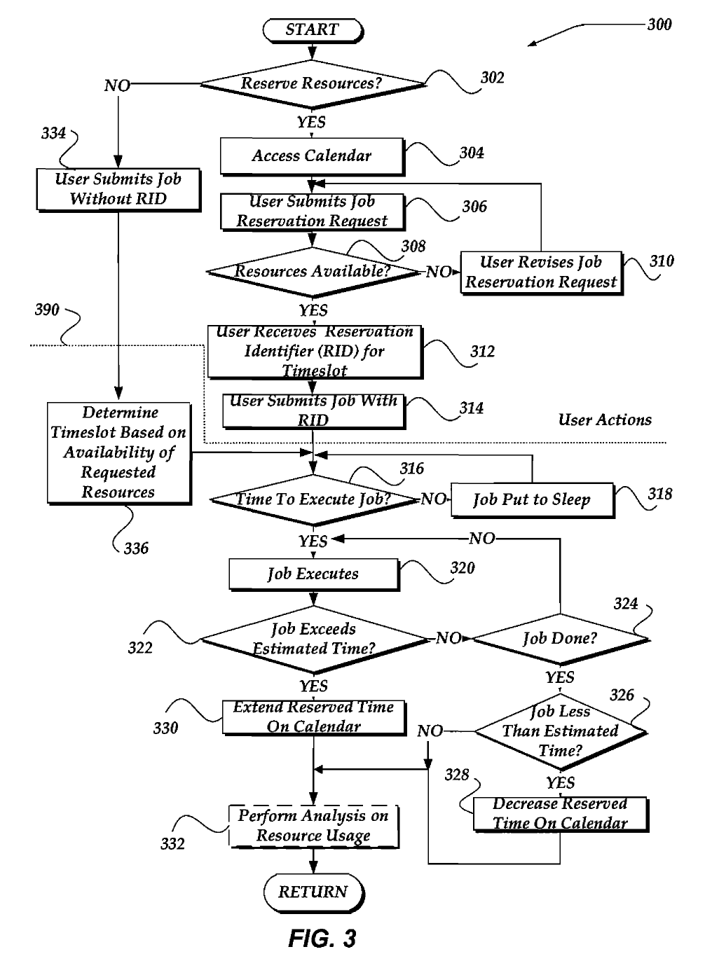

The operation of certain aspects of the invention will now be described with respect to FIG. 3. FIG. 3 illustrates a logical flow diagram generally showing one embodiment of a process for future job resource scheduling employing a calendaring interface. As shown, portions of process 300 of FIG. 3 may be performed by different entities. For example, in one embodiment, a user of a client device, such as client devices 101-103 of FIG. 1, may perform portions of those blocks in process 300 above dashed line 390. In one embodiment, at least some of the blocks below dashed line 390 may be performed by a scheduler wrapper application, a computer resource, a data analysis tool, or the like.

In any event, process 300 begins, after a start block, at decision block 302, where a user selects whether to reserve a timeslot for resources to execute a job sometime in the future, or to select automatic reservation (also called an ‘at once’ reservation) to execute a job at an earliest possible time. A reservation in the future indicates that the some time other than the next few minutes are being sought to execute the job. Thus, a future reservation is directed towards a user proactively postponing the execution of a job until some time in the future that is selected by the user. In one embodiment, future reservations provide a convenient approach for planning jobs that might be executed repetitively, or the like.

Future reservations are distinguished from automatic or ‘at once’ reservations, where a computer may select a time for execution of the job based on a variety of factors, including a characteristic of the user, a user group, a cluster, job queue, availability of a resource, or the like. Thus, if the user determines that the job is to be scheduled in the future proactively, processing flows to block 304; otherwise, processing branches to block 332, for automatic reservation of the job.

At block 304 the user may proactively select to schedule the job in the future by accessing and using a calendaring interface to select an available time for execution of the job. One embodiment of a calendaring interface useable for scheduling jobs is described in more detail below in conjunction with FIG. 4. Briefly, a user may graphically view available timeslots within a calendar view. In one embodiment, the calendar may inhibit display of timeslots, and/or resources that are unavailable to the user based on a policy, a service level agreement, or the like. However, in one embodiment, the calendar may display timeslots that are reserved by another user and therefore unavailable based on a prior reservation. Such timeslots might become available based on user negotiations, a user relinquishing the timeslot, or the like.

Processing flows next to block 306, where the user may select to submit a job reservation request. In one embodiment, the user may be presented with a pop-up window, a menu, or the like, for entering the reservation. One embodiment of such a reservation submission interface is described in more detail below in conjunction with FIG. 5. Briefly, however, the user may submit the request for the reservation using the interface by entering information about the resources requested for execution of the job. In one embodiment, the user may request a server, an application, an I/O device, or the like. In one embodiment, the user may submit an estimate of how long the job might be expected to take to execute.

Process 300 then continues to decision block 308, where a determination is made based, in part, on the user's request for resources, the user's service level agreements, a user's group, or the like, whether the resources are available to the user. For example, although the user may have viewed within a calendar user interface that a particular server is available at a particular time, once the user also specifies an application, or other resource for the job, the calendar may revise its display of available resources. Thus, a server may no longer be available at a particular timeslot, if the available licenses for a particular application are no longer available during that timeslot. Therefore, based on additional entered constraints by the user, the displayed available resources may change. If this is the case, such that the requested timeslot is no longer available to the user, processing flows to block 310; otherwise, the reservation request is accepted and processing flows to block 312.

At block 310, the user may revise their job reservation request by modifying the requested resources, by selecting another timeslot, or any of a variety of other actions. In any event, processing then loops back to block 306, where the user submits the modified reservation request, and continues until a timeslot is successfully reserved. It should be clear that the user may also, at virtually any point in the process, exit the calendar interface, even without scheduling a reservation.

At block 312, the user is provided a Reservation Identifier (RID) for the reserved timeslot. Processing continues to block 314, where the job is submitted for execution at the reserved timeslot. In one embodiment, the user may submit the job through a different interface, such as a CLI, another GUI, or the like. In another embodiment, submission of the job may occur at the time the user successfully reserved the timeslot. In any event, submission of the job includes providing the RID. In one embodiment, submission of the job includes providing the RID to a schedule wrapper program that is also associated with the job. Thus, for example, the user might employ a CLI or other interface to invoke a schedule wrapper with the job, and the RID. In one embodiment, the job may be identified to the schedule wrapper using a job number, job name, or the like.

In one embodiment, the job may be submitted to a reserved server resource. In another embodiment, the job may be submitted to any server within the cluster, or the like. Then, at some later time, the job may be moved to the reserved server resource to execute. For example, in one embodiment, the job may be moved when the schedule wrapper performs an analysis, when the schedule wrapper determines the job is to execute, or based on a variety of other criteria. In any event, processing proceeds to decision block 316.

Decision block 316, in one embodiment, may be performed by the schedule wrapper program for a job. In one embodiment, the schedule wrapper program may be configured to employ the RID, in part, to query a scheduling data store, such as SDS 252, of FIG. 2, or the like. Based on a result of the query, the schedule wrapper program may then determine whether to execute the job. If it is not time to execute the job, processing flows to block 318; otherwise, processing flows to block 320.

At block 318, the schedule wrapper may sleep for some predefined time period. In one embodiment, the schedule wrapper may enable sleep mode by calling an operating system sleep system call, or the like, for a predefined time. In one embodiment, the predefined time may be anywhere from a few seconds to several minutes, or even hours. However, the predefined time may be virtually any time period, without departing from the scope of the invention. When the schedule wrapper awakes, processing loops back to decision block 316, to again determine whether to execute the job.

At block 320, the job is executed. During execution, processing flows to decision block 322, where schedule wrapper may monitor the job to determine whether the job is exceeding an estimated job duration. If the job is exceeding the estimated time to complete, processing flows to block 330; otherwise, processing flows to decision block 324.

At block 324, a determination is made whether the job is completed. If it is completed, the flow proceeds to decision block 326; otherwise, processing loops back to block 320. At decision block 326, a determination is made whether the job completed in less time than was estimated for the job. If not, then processing flows to block 332. Otherwise, processing continues to block 328 where the timeslot on the schedule for the job may be modified to free up the unused time. In one embodiment, the schedule wrapper communicates with the scheduling data store to free up the unused resources and time. In another embodiment, the schedule wrapper may launch another application, script, process, applet, or the like, to communicate with the scheduling data store to free up the resources. In any event, processing then proceeds to block 332.

At block 330, the timeslot on the schedule for the job may be modified to reserve additional time for the resources for the job. In one embodiment, the schedule wrapper communicates with the scheduling data store to reserve the additional resources and time. In another embodiment, the schedule wrapper may launch another application, script, process, applet, or the like, to communicate with the scheduling data store to reserve the resources.

Moreover, in one embodiment, if another reserved timeslot might be affected based on the timeslot in which the job is currently exceeding, the invention may perform a variety of other actions based on a policy. For example, in one embodiment, the schedule wrapper may abort the current job, and/or notify the user associated with the job. In another embodiment, the schedule wrapper, or another program, may move the affected reservation to another timeslot, shorten the other reserved timeslot, notify a user associated with the affected timeslot, or the like. In any event, processing then proceeds to block 332.

Block 332 is an optional block (see dashed box). At optional block 332, usage reports may be generated. Such usage reports may be configured to track a variety of information assorted with the use of the resources, the calendaring interface, or the like. For example, in one embodiment, the usage reports may indicate a number of users that employ the calendaring interface and a number of user that employ at once job scheduling. The usage reports may further indicate how much of resource is reserved, how much is actually consumed, how much is relinquished, or the like, as well as which users, user groups use the resources, which resources may be over-utilized, under-utilized, or the like. However, the invention is not constrained to generating usage reports based on these examples, and virtually any information about job scheduling of resources may be generated, without departing from the scope of the invention.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Scheduler User Interfaces

FIG. 4 illustrates one embodiment of an example user interface useable as a calendaring interface for future job reservations. Interface 400 may include many more or less components than those shown. The components shown, however, are sufficient to disclose an illustrative embodiment for practicing the invention. Interface 400 may represent, for example, one embodiment of a calendaring interface useable to interface with SDS 253 of FIG. 2. Thus, in one embodiment, interface 400 may represent one embodiment of UI 252 of FIG. 2.

As shown, interface 400 illustrates an expandable and scrollable windowing type of interface. Thus, in one embodiment, interface 400 may employ various resizing icons 408, and scroll bars 406. In one embodiment, interface 400 may be displayed within a browser application.

Interface 400 is configured to enable a user to select a given year, month, week day, for view. The user may resize interface 400 using resizing icons 408, and/or scroll interface 400 to display a given resource using scroll bars 406. As shown, interface 400 is currently illustrating for a given day (for example, the 20^{th}), allocation of resources, S-108, S-109, and S-110. As shown, in the example, various users (garyt and kty) have reserved timeslots for the various resources. It should be noted, that while the display illustrates the reservations in rows, the display is not so limited, and any of a variety of other graphical representations may also be employed, including, for example, blocks, color coding of timeslots, boxes of reserved times, and/or unreserved times. In one embodiment, for example, the user might see available timeslots as opposed to reserved timeslots.

In any event, the user may view the available timeslots (in this example, the unreserved times). The user may then select for a given day, the new edit icon 402 to reserve a resource for a given time. In one embodiment, new edit icon 402 opens another window, menu, or the like, that enables the user to reserve a timeslot. One embodiment of a reservation window is described below in conjunction with FIG. 5.

FIG. 5 illustrates one embodiment of example user interface useable in submitting a job request to a scheduler. Interface 500 may include many more or less components than those shown. The components shown, however, are sufficient to disclose an illustrative embodiment for practicing the invention.

In one embodiment, interface 500 may automatically complete a user identifier field 502 based on a log-in or other available information about the user. In another embodiment, the user may be enabled to modify the user identifier field 502 content.

In one embodiment, interface 500 enables the user to specify a resource to be reserved 506, as well as any additional resources 508, such as applications, licenses, a peripheral, or the like. In one embodiment, where an additional resource 508 is not displayed on the calendaring interface, the invention may be configured to determine whether the resource is already reserved for that timeslot. If so, the user may be so informed, through interface 500, or the like, such that the user may change the reservation timeslot, the additional resources 508 being requested, or the like.

Interface 500 further enables the user to reserve a start date 510 for the job, along with a start hour 512, and start minute 514 for execution of the job. In one embodiment, start hour 512 and start minute 514 may employ a 24 hour entry system. In another embodiment, interface 500 may employ a 12 hour entry system, using AM and PM indicators, or the like. In any event, interface 500 may also, in one embodiment, enable the user to specify an expected end date 516, including an expected end hour 518, and end minute 519. One embodiment of interface 500 further enables a user to reserve recurring times 520 for the job.

In any event, the user may submit the job using a submit icon 522, or the like. In one embodiment, interface 500 may, if the reservation is successful, return a Reservation Identifier (RID) 504 for the scheduled job. Using interface 502 may result in revising what may be displayed within interface 400 of FIG. 4.

In one embodiment, the user may then employ the provided RID to submit the job for execution, using a schedule wrapper, or the like. In one embodiment, job submission may be performed using a CLI type of interface. For example, in one embodiment, the user may call the schedule wrapper and include various call option parameters, including the job identifier, and if available, the RID.

However, job submission for execution may also be performed using an interface such as interface 500, or the like. For example, in one embodiment, the user may open interface 500 and enter the RID obtained earlier. Entry of the RID may then result in the above mentioned times being automatically displayed to the user based on the user's earlier reservation actions. In another embodiment, where the user does not have an RID, such as during an at once job execution submission, the user might enter an immediate time into start date 510, start hour 512, and start minute 514. In one embodiment, the start date 510, start hour 512, and start minute 514, might automatically display the current date and time. The user may further complete the remaining entries for the submission of the at once job. The user then may submit the job for at once execution by so indicating the job to be an at once job using the at once icon 523, and then employing the submit icon 522.

Moreover, where the job is to be submitted as an at once job execution, the user may so indicate this using the at once job selection icon 524, and by further entering a job specification 526, such as a job number, job name, or other job identifier.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device for managing scheduling decisions for computer resources, comprising:
a transceiver for receiving and sending information;
a graphical user interface that is displayable to a user and configured to enable actions, including:
performing a search of a scheduling data store for at least one computing resource;
displaying information at a display device about the at least one computing resource in a calendar format, wherein the displayed information includes an identifier of the at least one computing resource, and a time when the at least one computing resource is available to be reserved;
receiving a user input configured to reserve the at least one computing resource;
modifying information in the scheduling data store to reserve the at least one computing resource based on the received user input; and
providing the user with a reservation identifier (RID) that enables the user to submit a job for execution using the reserved at least one computing resource.

2. The network device of claim 1, wherein the graphical user interface employs a web browser interface.

3. The network device of claim 1, wherein displaying information further comprises:
inhibiting display of at least one other computing resource within the scheduling data store for which the user is constrained from reserving.

4. The network device of claim 3, wherein receiving a user input configured to reserve further comprising:
displaying another interface configured to display fields for specifying the at least one computing resource to be reserved, a start time for reserving the at least one computing resource, or an expected duration time for an execution of the job;
receiving an entry within at least one of the displayed fields; and
updating the scheduling data store to include a reservation for the at least one computing resource.

5. The network device of claim 1, further comprising:
providing an interface to enable the user to call a schedule wrapper to submit the job for execution, with the RID, wherein
the schedule wrapper is configured to employ the RID to determine when to execute the job.

6. The network device of claim 5, wherein the schedule wrapper is configured to perform actions, further comprising:
querying the scheduling data store using the RID to determine when to execute the job;
if a result of the query indicates the job is not to begin execution, sleeping for a defined period of time; and
if the result of the query indicates that the job is to begin execution, submitting the job for execution.

7. The network device of claim 6, wherein the schedule wrapper is configured to perform actions, further comprising:
determining if the job is exceeding an estimated time to complete, and if so, then enabling the scheduling data store contents to be modified to reserve an additional amount of time for the at least one computing resource.

8. The network device of claim 6, wherein the schedule wrapper is configured to perform actions, further comprising:
determining if the job is consumed less time than an estimated time to complete, and if so, then enabling the scheduling data store contents to be modified to un-reserve the unused amount of time for the at least one computing resource.

9. A method of managing scheduling decisions of resources over a network, comprising:
displaying to a user a calendaring interface that is configured to display information about computing resources and timeslots in which the computing resources can be reserved;
receiving from a user a reservation request through the calendaring interface to reserve at least one computing resource during a specified timeslot;
updating a scheduling data store based on the reservation request;
updating the calendaring interface to display that the at least one computing resource is reserved for the specified timeslot;
providing the user with a reservation identifier (RID); and
enabling the user to submit a job for execution based on the reservation request and RID.

10. The method of claim 9, further comprising:
enabling the user to submit another job absent a reservation identifier;
determining a time to execute the other job based on at least one of a least loaded or a most available mechanism;
determining another RID for the other job; and
automatically submitting the other job with the other RID, such that the other job is enabled to execute based on the determined time.

11. The method of claim 9, wherein enabling the user to submit the job for execution further comprises, providing access to a schedule wrapper using at least one of a CLI or a graphical user interface, wherein the schedule wrapper is configured to perform actions, including:
employing the RID to query the scheduling data store to determine if it is time to execute the job;
if it is determined to be time to execute the job, launching the job to an operating system for execution; and
if it is determined not to be time to execute the job, sleeping for a defined time period, and then rechecking to determine if it is time to execute the job.

12. The method of claim 9, wherein displaying to the user a calendaring interface further comprises employing a browser interface to display the calendaring interface.

13. The method of claim 9, wherein the calendaring interface is further configured to inhibit display of at least one computing resource that the user is inhibited from reserving, based on a user group, a quality of server agreement, a license constraint, or a service level agreement.

14. The method of claim 9, wherein receiving a request to reserve during a specified timeslot further comprises receiving a request to reserve a recurring timeslot.

15. A modulated data signal configured to include program instructions for performing the method of claim 9.

16. A system for use in managing a scheduling of jobs to resources, comprising:
a scheduling data store that is configured to receive and manage computing resources; and
a calendaring interface that is configured to perform actions, including:
querying the scheduling data store to identify timeslots when a computing resource is unreserved and timeslots when the computing resource is reserved;
displaying to a user, in a calendaring format, based, in part on the query, the timeslots in which the computing resource is reserved, and the timeslots in which the computing resource is available to the user to reserve;
receiving from the user a request to reserve the computing resource for an available timeslot;
providing the user with a reservation identifier (RID) for the requested reservation;
updating the scheduling data store based on the request to indicate that the computing resource is reserved by the user during the requested timeslot; and
enabling the user to submit a job for execution during the reserved timeslot using the reserved at least one computing resource based on the RID.

17. The system of claim 16, wherein enabling the user to submit the job for execution further comprises, providing at least one of a command line interface or a graphical interface to the user, that enables access to a schedule wrapper, wherein the schedule wrapper is configured to perform actions, including:
querying the scheduling data store to determine if it is time to execute the job;
if it is determined to be time to execute the job, launching the job to an operating system for execution; and
if it is determined not to be time to execute the job, sleeping for a defined time period, and then rechecking to determine if it is time to execute the job.

18. The system of claim 16, further comprising:
a scheduler wrapper that is configured to perform actions, including:
determining when to execute the submitted job based on the RID;
enabling execution of the job based on the requested reservation;
if the executing job is exceeding an expected time to complete, then reserving an additional amount of the computing resource for the job; and
if the job execution is completed within less than the reserved timeslot, then revising the reserved timeslot to un-reserve an unused portion.

19. The system of claim 16, further comprising:
a schedule wrapper that is configured to perform actions, including:
if another job is submitted with the schedule wrapper absent an RID, determining a time on the computing resource to execute the other job based on at least one of a round robin, a most available, or a least loaded mechanism.

20. The system of claim 16, wherein the computing resource comprises a cluster of compute servers.
